(19) United States
(12) Patent Application Publication
(10) Pub. No.: US 2010/0017203 A1
(43) Pub. Date: Jan. 21, 2010

(54) AUTOMATIC LEVEL CONTROL OF SPEECH SIGNALS

(75) Inventor: Fitzgerald John Archibald, Kanyakumari District (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/472,393

(22) Filed: May 27, 2009

(30) Foreign Application Priority Data
Jul. 15, 2008 (IN) 1708/CHE/2008

(51) Int. Cl. G10L 11/06

(52) U.S. Cl. 704/208

(57) ABSTRACT

A method and apparatus for processing audio signals. The method includes receiving an audio signal as a sequence of digital samples, said audio signal containing a speech portion and a non-speech portion, dividing said sequence of digital samples into a sequence of sub-frames, selecting a set of sub-frames from said sequence of sub-frames, said set including a current sub-frame, determining whether a difference of peak values for any pair of sub-frames is greater than a pre-determined threshold, wherein said pair of sub-frames are contained in said set of sub-frames, and concluding that said current sub-frame represents said speech portion if said difference of peak values exceeds said pre-determined threshold.

### RELATED APPLICATION(S)

The present application claims the benefit of co-pending India provisional application serial number: 1708/CHE/2008, entitled: “Method for Automatic Gain Control of Speech Signals”, filed on Jul. 15, 2008, naming Texas Instruments, Inc. (the intended assignee of this US Application) as the Applicant, and naming the same inventor as in the present application as inventor, attorney docket number: TXN-235, and is incorporated in its entirety herewith.

### BACKGROUND OF THE INVENTION

1. Technical Field

Embodiments of the present disclosure relate generally to speech processing, and more specifically to automatic level control (ALC) of speech signals.

2. Related Art

Speech signals generally refer to signals representing speech (e.g., human utterances). Speech signals are processed using corresponding devices/components, etc. For example, a digital audio recording device or a digital camera may receive (for example, via a microphone) an analog signal representing speech and generate digital samples representing the speech. The samples may be stored for future replay or may be replayed in real time, often after some processing.

There is often a need to perform level control of the speech signal. Level control refers to amplifying the speech signal by a desired degree (“gain factor”) for each portion, with the desired degree often varying between portions. Automatic level control (ALC) refers to determining such specific degrees for corresponding portions without requiring human interference; for example, to specify the gain factor or degree of amplification. ALC may need to be performed consistent with one or more desirable features.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An aspect of the present invention determines that a sub-frame of an audio signal represents speech if the difference of peak values corresponding to a pair of sub-frames in a frame containing the sub-frame exceeds a threshold value. In an embodiment, the peak values of sub-frames within a frame are filtered and the filtered peak values are used associated with the respective sub-frames.

Another aspect of the present invention changes a noise floor dynamically based on the digital values representing the audio signal, during processing of the audio signal. In an embodiment, when a sub-frame is concluded to be a speech segment, the least of the peak values of the sub-frames in the corresponding frame is equated to be the updated noise floor for processing later segments of the audio signal.

One more aspect of the present invention uses different mathematical relations to determine gain values for different amplitude ranges of the audio signal. Such a feature may be used, for example, to preserve distance perception (when listening to the processed audio signal), while attempting to make substantial use of the output (amplified) range available for the amplified signal.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### BRIEF DESCRIPTION OF THE VIEWS OF DRAWINGS

Example embodiments of the present invention will be described with reference to the accompanying drawings briefly described below.

FIG. 1 is a block diagram of an example device in which several aspects of the present invention can be implemented;

FIG. 2A is a diagram used to illustrate automatic level control of a speech signal;

FIG. 2B is a diagram illustrating the manner in which audio samples are operating upon;

FIG. 3 is a flowchart illustrating the manner in which ALC of speech signals is provided in an embodiment of the present invention;

FIG. 4A is a flowchart illustrating the manner in which noise floor is dynamically determined, in an embodiment of the present invention;

FIG. 4B is a diagram illustrating example noise and speech waveforms, and to illustrate how speech may be detected even in the presence of stationary noise of large amplitude;

FIG. 5 is a flow chart illustrating the manner in which ALC is provided, in an embodiment of the present invention;

FIG. 6 is a flowchart illustrating the manner in which gain shaping is provided, in an embodiment of the present invention;

FIGS. 7A and 7B are graphs respectively illustrating the relationship between input-processed output amplitudes of an audio signal, and input amplitude-gain applied in an embodiment of the present invention;

FIGS. 8A and 8B are graphs respectively illustrating the relationship between input-processed output amplitudes of an audio signal, and input amplitude-gain applied in an embodiment of the present invention;

FIGS. 9A and 9B are graphs respectively illustrating the relationship between input-processed output amplitudes of an audio signal, and input amplitude-gain applied in an embodiment of the present invention; and

FIG. 10 is a diagram of example waveforms illustrating graphically the operation of several features of the present invention.

The drawing in which an element first appears is indicated by the leftmost digit(s) in the corresponding reference number.

### DETAILED DESCRIPTION

Various embodiments are described below with several examples for illustration. Throughout this application, a machine readable medium is any medium that is accessible by a machine for retrieving, reading, executing or storing data.

1. Example Device

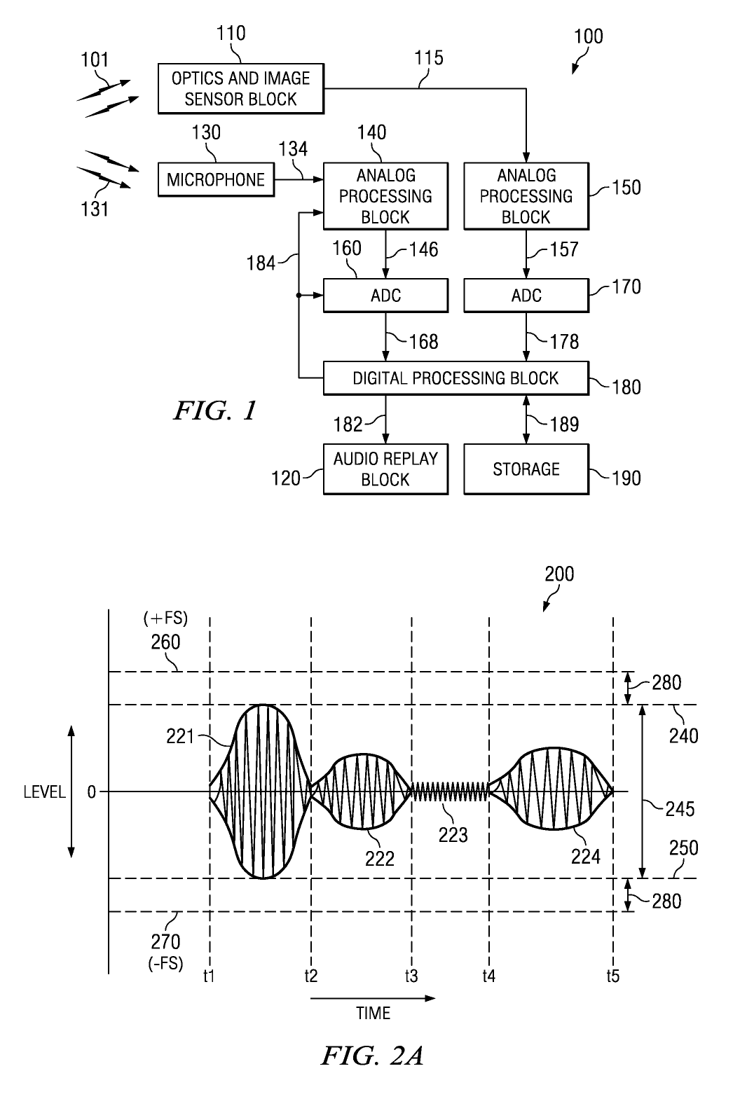

FIG. 1 is a block diagram of an example device in which several aspects of the present invention can be implemented. Digital still camera 100 is shown containing optics and image sensor block 110, audio replay block 120, microphone 130, analog processing blocks 140 and 150, analog to digital converters (ADC) 160 and 170, digital processing block 180 and storage 190.

Optics and image sensor block 110 may contain lenses and corresponding controlling equipment to focus light beams 101 from a scene onto an image sensor such as a charge coupled device (CCD) or CMOS sensor. The image sensor contained within optics and image sensor block 110 generates electrical signals representing points on the image of scene 101, and forwards the electrical signals on path 115.

Analog processing block 150 performs various analog processing operations on the electrical signals received on path 115, such as filtering, amplification etc., and provides the processed image signals (in analog form) on path 157. ADC 170 samples the analog image signals on path 157 at corresponding time instances, and generates corresponding digital codes representing the strength (e.g., voltage) of the sampled signal instance. ADC 170 forwards the digital codes representing scene 101 on path 178.

Microphone 130 receives sound waves (131) and generates corresponding electrical signals representing the sound waves on path 134. Analog processing block 140 performs various analog processing operations on the electrical signals received on path 134, such as filtering, amplification etc, and provides processed audio signals (in analog form) on path 146.

ADC 160 samples the analog audio signals on path 146 at corresponding time instances, and generates corresponding digital codes. ADC 160 forwards the digital codes representing sound 131 on path 168. Optics and image sensor block 110, audio replay block 120, microphone 130, analog processing blocks 140 and 150, and ADCs 160 and 170 may be implemented in a known way.

Storage 190, which may be implemented as any type of memory (with associated hardware), may store raw (unprocessed) or processed (digitally by digital processing block 180) audio and image data, for streaming (real time reproduction/replay) or for replay at a future time. Storage 190 may also provide temporary storage required during processing of audio and image data (digital codes) by digital processing block 180.

Specifically, storage 190 may contain non-volatile memory such as a hard drive, removable storage drive, read-only memory (ROM), flash memory, etc. In addition, storage 190 includes random access memory (RAM). Storage 190 may store the software instructions (to be executed on digital processing block 180) and data, which enable digital still camera 100 to provide several features in accordance with the present invention.

Some or all of the data and instructions may be provided on storage 190, and the data and instructions may be read and provided to digital processing block 180. Any of the units (whether volatile or non-volatile, removable or not) within storage 190 from which digital processing block 180 reads such data/instructions, may be termed as a machine readable storage medium.

Audio replay block 120 may contain digital to analog converter, amplifier, speaker etc., and operates to replay an audio stream provided on path 182. The audio stream on paths 182/189 may be provided incorporating ALC.

Digital processing block 180 receives digital codes representing scene 101 on path 178, and performs various digital processing operations (image processing) on the codes, such as edge detection, brightness/contrast enhancement, image smoothing, noise filtering etc.

Digital processing block 180 receives digital codes representing sound 131 on path 168, and performs various digital processing operations on the codes, including automatic level control (ALC) of signals/noise represented by the codes. Digital processing block 180 may apply corresponding gain factors, as determined by the ALC approach, either to the digital samples (within digital processing block 180) or to either or both of analog processing block 140 and/or ADC 160 via path 184. Digital processing block 180 may be implemented as a general purpose processor, application-specific integrated circuit (ASIC), digital signal processor, etc.

A brief conceptual description of ALC of speech signals is provided next with respect to an example waveform. Though ALC is described below with respect to digital processing block 180, it should be appreciated that the features of the present invention can be implemented in other systems/environments, using other techniques, without departing from several aspects of the present invention, as will be apparent to one skilled in the relevant arts by reading the disclosure provided herein.

2. Audio Signal

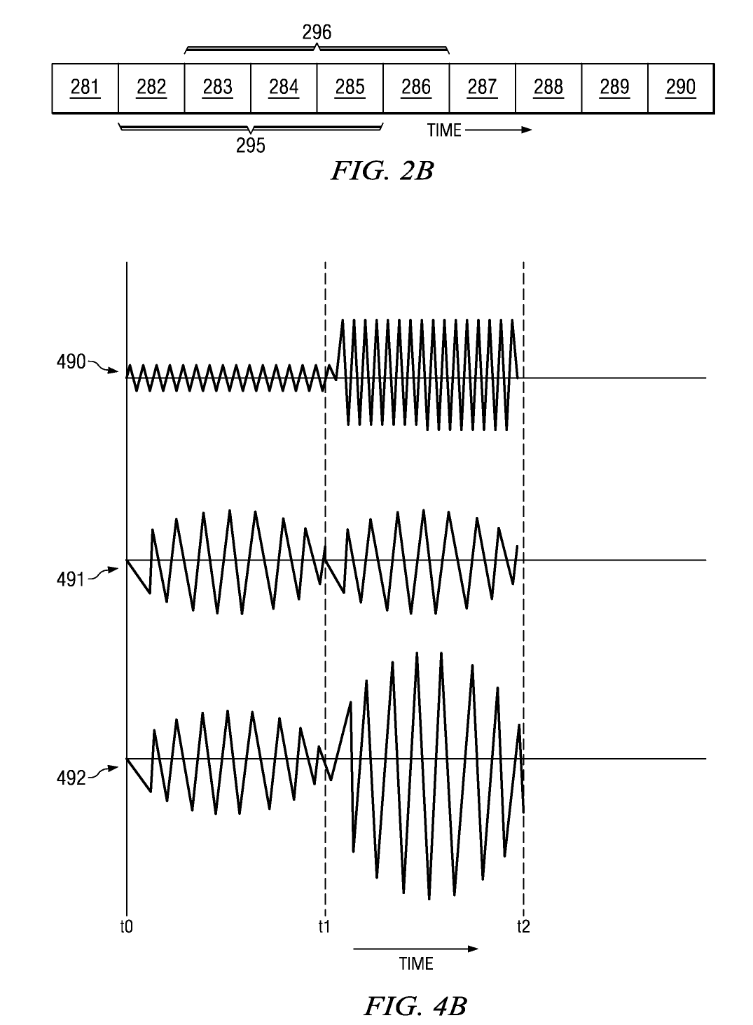

FIG. 2A is a diagram used to illustrate ALC of a speech signal. The diagram shows an audio (sound) signal 200. For simplicity, sound signal 200 is shown as a continuous waveform. However, the sound signal 200 may also represent digital codes, as may be provided on path 168 (FIG. 1). +FS (260) and −FS (270) denote, respectively, the positive and negative full-scale levels representable by digital codes in digital processing block 180. For example, assuming that the maximum length of codes processed in digital processing block 180 is 16 bits, +FS and −FS would equal the numbers +32767 and −32768 respectively, and the full-scale range (+FS−(−FS)) would equal 96 dB.

Portion 221 of audio (or sound) signal 200 contained between time instances t1 and t2 is shown as having a peak level (amplitude) denoted by markers 240 (positive peak) and 250 (negative peak). Portions 222, 223 and 224, in respective intervals t2-t3, t3-t4 and t4-t5 are shown as having peak amplitudes less than that of portion 221. Portions 221, 222 and 224 may represent speech, while portion 223 may represent non-speech/noise.

It may be desirable to control the level/amplitude of speech portions in audio signal 200 such that the range +FS to −FS is adequately used in representing the speech portions (or generally, utterances, noted in the background section), while also restricting the maximum amplitudes to lie within levels 240 and 250 (i.e., range 245). Such restriction of the peak values may be desired to prevent inadvertent signal clipping, and ‘headroom’ 280 may correspondingly be provided.

Accordingly, corresponding gain factors may be applied according to ALC techniques to amplify speech portions 222 and 224, to raise the respective peak values to level 240/250. Noise portion 223, on the other hand, may need to be attenuated, or at least not amplified.

It should be appreciated that the gain requirements of above are to be provided without changing the relative amplitude characteristics at a micro level, such that the nature of the audio signal is still preserved. For example, it is noted here that there may be substantial variations (as may be observed from FIG. 2A) in the instantaneous signal-levels of a speech portion. Such relative variations at micro-level are inherent in the speech signal itself, and may need to be preserved.

Before the gain factors are applied, an ALC technique typically needs to determine which portions of an audio signal represent speech, and which represent noise. Accordingly, the audio signal or the corresponding digital samples representing the audio signal may need to be processed suitably to enable the speech or noise determination. Accordingly, a brief description of the manner in which audio samples are operated upon is described next.

3. Moving Window of Sub-Frames

FIG. 2B is a diagram illustrating the manner in which digital processing block 180 operates on audio samples. Digital processing block 180 divides received audio samples into a sequence of sub-frames. It may be appreciated that a set of successive sub-frames are together are analyzed (for a present frame) below for several decisions related to ALC, and such set may be viewed as a frame in relation to the present sub-frame. As the present sub-frame changes, the frame also ‘slides’ forward to select the corresponding sequence of sub-frames.

While the description below is provided using a fixed number of sub-frames for each current sub-frame, variable number may be employed in alternative embodiments without departing from the scope and spirit of several aspects of the present invention. Similarly, while only prior sub-frames are shown being used in ALC related determinations with respect to a current sub-frame, it may be appreciated that buffering techniques can be used to include ‘later’ sub-frames corresponding to a current sub-frame, in alternative embodiments of the invention.

In FIG. 2B, 281-290 represent an example sequence of sub-frames formed by digital processing block 180, with each sub-frame containing multiple samples (digital codes representing an audio signal). Sub-frame 281 is the earliest sub-frame received/formed, while 290 is the latest sub-frame received/formed.

Digital processing block 180 may select the number of samples to be grouped together as a sub-frame, (i.e., size of a sub-frame) based on the nature of the audio signal, the sampling rate of ADC 160, the source of the input signal (if known a priori), etc. In general, the size/duration of each sub-frame needs to be sufficiently small such that sufficient control is available, (for example, to amplify or attenuate) each portion. At the same time, the duration needs to be large enough such that the speech characteristics are not altered (due to subsequent application of gain) within a speech segment (a speech segment may contain one or more sub-frames).

Digital processing block 180 may determine a peak level for each sub-frame based on corresponding peak sample values in earlier sub-frames. Thus, for example, assuming sub-frame 285 is the currently processed (for ALC) sub-frame (‘current’ sub-frame), digital processing block 180 may determine a peak corresponding to sub-frame 285 by determining the peak sample within sub-frame 285 as well as peaks determined for earlier sub-frames 281-285 (together termed as a frame for the current sub-frame 285).

In an embodiment, digital processing block 180 selects the largest of the peaks in each of sub-frames 281, 282, 283, 284 and 285, as the peak corresponding to sub-frame 285. Similarly, digital processing block 180 may assign the largest of the peaks in each of sub-frames 282, 283, 284, 285 and 286, as the peak corresponding to sub-frame 286.

Thus, in the embodiment, digital processing block 180 determines peak values for each of a sequence of “windows” (such as 290 and 295 of FIG. 2B) that move or slide in time as each new sub-frame is formed. It is noted that a sequence of peaks determined as noted above approximates an envelope of the audio samples, and such operation may be viewed as a low-pass filtering operation of the input (audio signal), and the peaks as representing a pseudo-envelope of the audio signal.

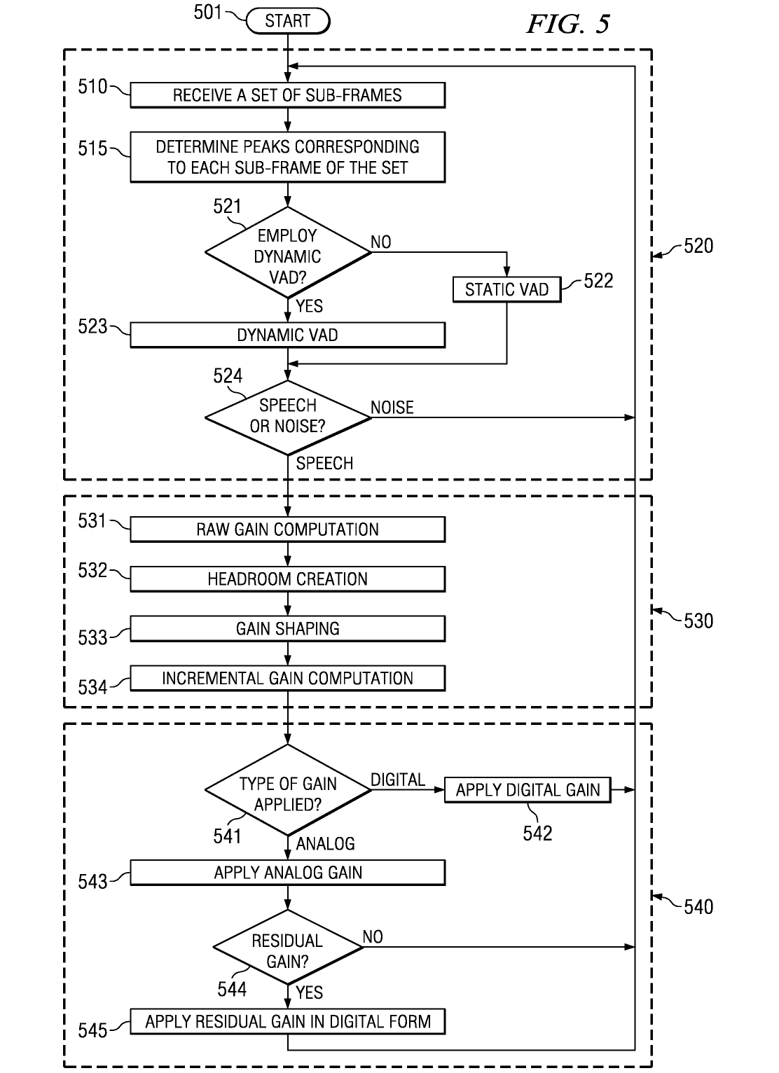

In alternative embodiments, other techniques, such as averaging the peaks of sequences (overlapping or non-overlapping) of sub-frames may be instead be used to select a peak for a current sub-frame. In yet another embodiment of the present invention, peak detection is performed based on the squared values of the audio samples to amplify variations in signal amplitudes and therefore signal separation from the noise floor. If squared signal is used, the thresholds/constants used in ALC (described below with respect to FIG. 5) are correspondingly modified. In yet another alternative embodiment, the peak values may be used without any effective filtering operation. Irrespective of the filtering technique or otherwise, a peak value is determined associated with each of the sub-frames. Digital processing block 180 may store the peaks associated with (or corresponding to) respective sub-frames in a buffer within storage 190 for later processing, as described below.

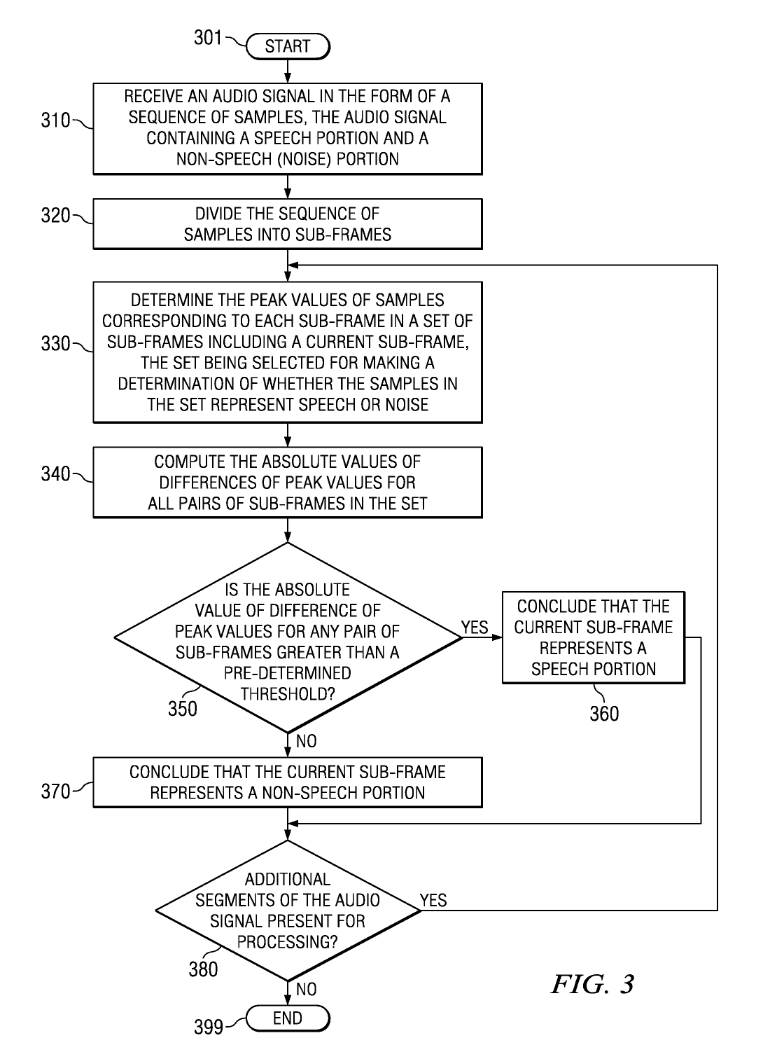

Digital processing block 180 may use the peak values assigned in the manner noted above to determine whether a segment (e.g., sub-frame) represents speech or non-speech, as described in detail below with respect to the flowchart of FIG. 3.

4. Automatic Level Control of Speech Signals

FIG. 3 is a flowchart illustrating the manner in which a processor determines speech and noise portions of a signal, in an embodiment of the present invention. The flowchart is described with respect to FIGS. 1 and 2, and digital processing block 180 merely for illustration. However, various features described herein can be implemented in other environments, as will be apparent to one skilled in the relevant arts by reading the disclosure provided herein. The flowchart starts in step 301, in which control is transferred to step 310.

In step 310, digital processing block 180 receives an audio signal in the form of a sequence of samples (e.g., digital codes as may be provided on path 168). The audio signal contains a speech portion and a non-speech (noise) portion. Control then passes to step 320.

In step 320, digital processing block 180 divides the sequence of samples into sub-frames. In an embodiment, each sub-frame equals (or contains) successive samples corresponding to 20 milliseconds duration. Control then passes to step 330.

In step 330, digital processing block 180 may determine the peak value (xpk) corresponding to each sub-frame in a ‘set’ of sub-frames. The set of sub-frames contains successive sub-frames including a current sub-frame, and the peak values of the sub-frames in the set are used as a basis to determine if the current sub-frame represents speech or noise. It is noted that if the respective peak values have already been determined earlier and stored in memory (as described with respect to FIG. 2B), digital processing block 180 may simply retrieve the peak values from memory. The peak values represent the envelope of the audio signal, and are obtained as described above with respect to FIG. 2B.

In an embodiment of the present invention, the ‘set of sub-frames’ contains eight successive sub-frames (Npkobs) including a current sub-frame. Thus, with respect to FIG. 2B, assuming sub-frame 289 is the current sub-frame, the set contains sub-frames 281-289, and digital processing block 180 determines (or simply retrieves if already available) the peaks corresponding to each of sub-frames 281-289 of the set. Control then passes to step 340.

In step 340, digital processing block 180 may compute the absolute values of differences (xpkdiff) of all pairs of peak values of the set of sub-frames. Thus, in an embodiment in which eight peak values (corresponding to eight consecutive sub-frames, as noted above) are considered for a speech or noise decision, digital processing block 180 may compute the (absolute value of) the difference between each of the possible pairs (⁸C₂=28 pairs) of peak values from the eight peak values (or alternatively computation may be stopped when the step of 350 is realized to be true for a given pair). Control then passes to step 350.

In step 350, digital processing block 180 determines if the absolute value of at least one difference obtained in step 340 is greater than a predetermined threshold (DPK_{TH}). The predetermined threshold (DPK_{TH}) may be determined, for example, based on the characteristics of speech. If the absolute value of at least one difference (xpkdiff) is greater than the threshold, control passes to step 360. Otherwise control passes to step 370.

In step 360, digital processing block 180 concludes that the current sub-frame (289 in the example above) represents speech (va[k]=1). In an embodiment of the present invention, if more than a threshold number (Nvak) of consecutive sub-frames are determined to be speech portions, then the current sub-frame is classified as representing noise (i.e., va[k] is forced to value 0, thus indicating noise), thus overriding the operations of steps 350 and 360 (which may not have to be performed in such a scenario). Such overriding may serve as a precautionary measure to address false positive detection of speech, and hence to prevent inadvertent noise amplification (a very large number of consecutive speech sub-frames being unlikely as speech typically contains ‘pauses’ between actual speech activity intervals). Control then passes to step 380.

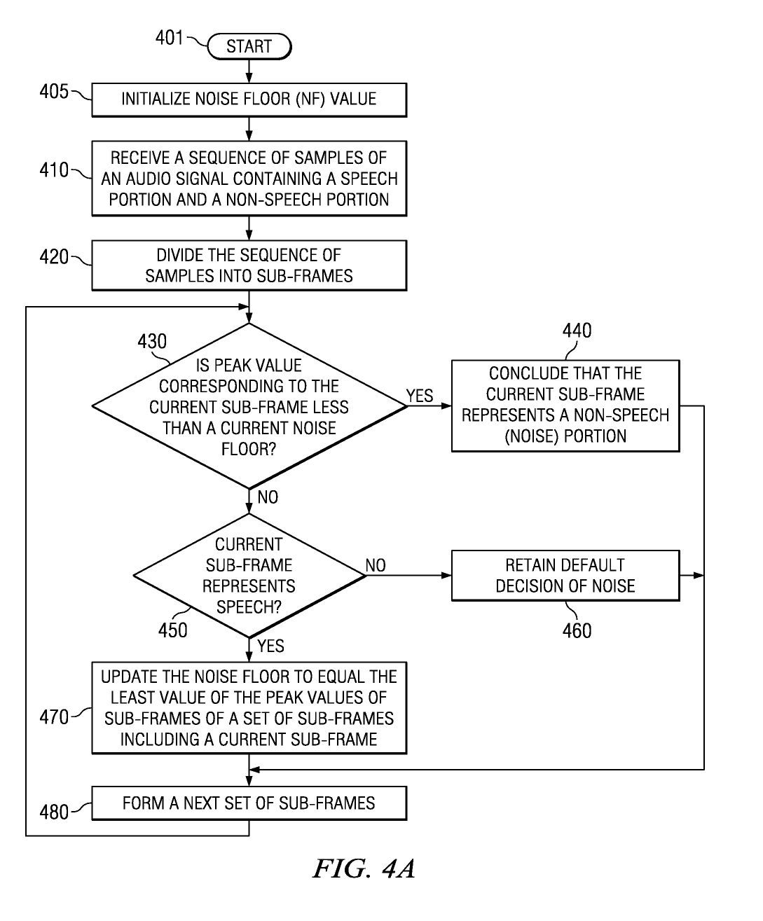

In step 370, digital processing block 180 concludes that the current sub-frame represents (is contained in) a non-speech portion (noise or silence), i.e., (va[k]=0). It is noted that upon initialization of the ALC technique, a default assumption of noise level (va[k]=0) may be made, since there may not be sufficient number of sub-frames (Npkobs) for a reliable determination of speech. Hence, if speech is determined not to be present, the default assumption of noise may be maintained (va[k]=0). Alternatively, or in other embodiments, noise determination may be made if the peak value corresponding to the current sub-frame is less than a noise floor, as described with respect to flowchart of FIG. 4A.

Control then passes to step 380, in which a check is performed to determine whether additional portions/segments (e.g., a newer set of sub-frames) of the audio signal are present for processing. Control transfers to step 330 if additional portions are present, and to step 399 otherwise. When control transfers to step 330, a next set of sub-frames (282-290 in the example) is processed to determine whether sub-frame 290 represents speech or not.

Corresponding gain factors may be applied for sub-frames determined to represent speech, while noise (used synonymously with non-speech since noise is always present) sub-frames may be attenuated (or at least not amplified). Application of gain/attenuation is described further in sections below.

Thus, according to an aspect of the present invention, signal variation (as represented by difference between peak values of selected sub-frames) is used to determine speech activity in an audio signal. Such a feature is based on an observation that speech portions typically exhibit wide variations in (instantaneous) amplitudes/levels with respect to time, whereas noise portions generally exhibit only very little variation in amplitude with respect to time.

It is noted here that stationary noise typically results in a substantially flat (minimum variations) envelope in the absence of speech signal, irrespective of the noise floor level, i.e., noise amplitude. On the other hand, speech signals typically exhibit fairly large variations irrespective of whether stationary noise is present or absent. Thus, the above approach enables reliable detection of speech (voice activity) even in the presence of stationary (non-varying peak amplitude) noise with large amplitude. An example illustration of the technique described above is provided with respect to FIG. 4B.

In FIG. 4B, waveform 490 represents noise and waveform 491 represents speech. In interval t0-t1 noise is shown as having a small amplitude (small filtered peak), while in interval t1-t2 noise is shown as having a (relatively) larger amplitude (larger filtered peak). Speech signal 491 is shown as having a relatively same amplitude in both the intervals t0-t1 as well as t1-t2. Waveform 492 represents the addition of the corresponding noise and speech portions of waveforms 490 and 491, and thus represents a portion of an input audio containing speech plus noise, as might be received on path 134 (FIG. 1), or provided as digitized samples on path 168.

Since speech signals typically exhibit fairly large variations irrespective of whether stationary noise is present or absent, it may be appreciated that the technique of comparing the difference of a pair(s) of peaks rather than the peak itself against a threshold would be a more reliable indication of speech. The speech detection technique of above may thus be reliably employed when speech needs to be detected even in fairly noisy environments.

Although in the flowchart above, a decision that a sub-frame represents noise is described as being made if the absolute value of at least one of the peak value differences is not greater than the predetermined threshold, in alternative embodiments such a decision may be based on other additional considerations, as well.

In an embodiment of the present invention, a sub-frame is deemed to represent noise if the magnitude of the peak sample corresponding to the sub-frame is less than a noise floor (NF). The NF itself is recomputed dynamically to account for changes in the noise floor of (corresponding circuit portions of) digital still camera 100. Such changes can occur, for example, as a result of a change in the operating temperature, automatic level control (ALC), etc, change in background noise (e.g., noise due to a vehicle, operation of air-conditioners in the vicinity, etc.) as is well known in the relevant arts. The manner in which noise floor is dynamically computed according to an aspect of the present invention is described below next.

5. Computing Noise Floor

FIG. 4A is a flowchart illustrating the manner in which NF is dynamically determined, in an embodiment of the present invention. The flowchart is described with respect to FIGS. 1 and 2, merely for illustration. However, various features described herein can be implemented in other environments, as will be apparent to one skilled in the relevant arts by reading the disclosure provided herein. The flowchart starts in step 401 in which control is transferred to step 405.

In step 405, digital processing block 180 initializes the Noise Floor (NF) to an estimated value. The estimated/initial value is typically determined based on system noise specifications, characteristics and specifications of components ahead in the signal chain, etc. With respect to FIG. 1, for example, the initial NF value may be determined based on operating characteristics of microphone 130, analog processing block 140, ADC 160, noise within digital processing block 180, in addition to other factors. The estimated value can be more or less than the accurate value eventually sought to be determined for the present operating conditions. At initialization, digital processing block 180 assumes that the current sub-frame represents noise, since sufficient sub-frames may not be available to reliably make a determination of speech. Control then passes to step 410.

In step 410, digital processing block 180 receives an audio signal in the form of a sequence of samples, the sequence of samples containing a speech portion and a non-speech (noise) portion (similar to in step 310). Control then passes to step 420, in which digital processing block 180 divides the sequence of samples into sub-frames (similar to in step 320). Control then passes to step 430.

In step 430, digital processing block 180 checks if the peak value corresponding to the current sub-frame is less than a current noise floor. If the peak value of the current sub-frame is less than the current noise floor, control passes to step 440. If the peak value of the current sub-frame is equal to or greater than the current noise floor, control passes to step 450.

In step 440, digital processing block 180 concludes that the audio portion corresponding to the current/present sub-present represents (is contained in) a non-speech (noise) portion. Control then passes to step 480.

In step 450, digital processing block 180 determines whether the current sub-frame represents speech. The determination may be made in a manner described above with respect to the flowchart of FIG. 3 (steps 350 and 360 of FIG. 3). If the current sub-frame is determined as representing speech (va[k]=1), control passes to step 470, otherwise control passes to step 460.

In step 460, digital processing block 180 retains the default (initial) assumption of the current sub-frame as representing noise (va[k]=0). Control then passes to step 480. In step 470, digital processing block 180 updates the noise floor (NF) to equal the least of the peak values in the set. In an embodiment, a noise floor margin (NFmargin) is then added to the updated noise floor, and the sum represents the new NF. Control then passes to step 480.

In step 480, digital processing block 180 forms a next set of sub-frames, while treating a next (immediate) sub-frame as a current sub-frame. Control then passes to step 430, and the operations in the corresponding blocks are repeated.

It may thus be appreciated that the NF value is generally increased during amplification of speech portions, while again reduced to a low value once the amplification is not applied during non-speech portions. In general, gaining the speech signal has the effect of increasing the NF of the system, and the increment to NF reflects such a phenomenon. On the other hand, the NF of the system is low when amplification is not performed, and thus step 450 operates to reset NF to a lower value when processing non-speech portion.

NF determined dynamically as described above helps avoid inadvertent noise amplification. While the flowcharts of FIGS. 3 and 4 are described above separately, it may be appreciated that the corresponding operations therein may be combined in an ALC technique. The combined operations, as well as additional operations performed by an ALC technique according to aspects of the present invention, are described next with respect to FIG. 5.

6. Combined Operation

FIG. 5 is a flow chart illustrating the manner in which ALC is provided, in an embodiment of the present invention. The flowchart is described with respect to FIGS. 1 and 2, and digital processing block 180, merely for illustration. However, various features described herein can be implemented in other environments, as will be apparent to one skilled in the relevant arts by reading the disclosure provided herein.

It is noted that the steps are shown separately merely for the sake of illustration, and the operations of two or more blocks may also be combined in a single block. Further, while shown as a flowchart with sequentially executed steps, two or more of the steps may also be executed concurrently, or in a time-overlapped manner. The steps may conveniently be grouped as speech/noise determination phase (520), gain determination phase (530) and gain application phase (540). The flowchart starts in step 501, in which control passes immediately to step 510.

In step 510, digital processing block 180 receives a set of sub-frames. The sub-frames in the set are selected to number as many as required to make a reliable determination of speech or noise. In an embodiment of the present invention, eight successive frames including a latest received (current) sub-frame are selected to form the set. Control then passes to step 515.

In step 515, digital processing block 180 determines the values of peak samples corresponding to each sub-frame in the set. The determination may be made in a manner described above with respect to FIG. 2B. Digital processing block 180 may store the peak values in storage 190. Control then passes to step 521.

In step 521, digital processing block 180 checks which type of VAD (Voice Activity Detection) technique is specified as having to be used to detect whether the set represents speech or noise. The selection may be based, for example, on a user-specified input (via an input device, not shown). If dynamic VAD is specified, control passes to step 523, otherwise control passes to step 522.

In step 522, digital processing block 180 performs a detection technique (static VAD), in which a sub-frame is deemed to correspond to a speech portion if the absolute magnitude of the peak sample in the sub-frame is above a predetermined threshold, and to noise portion otherwise.

The predetermined threshold/NF level in the static VAD technique is fixed (static), and not updated dynamically (except, optionally, when gain is applied subsequently in the analog domain). Digital processing block 180 makes a speech or non-speech decision, as expressed by the relationships below:

va[k]=1, if xpk[k]>XPK_{TH} Equation 1

va[k]=0, if xpk[k]<XPK_{TH} Equation 2

wherein,

va[k] is a flag specifying whether the current sub-frame [k] represents speech (va[k] equals 1) or noise (va[k] equals 0),

xpk[k] is the sample with the largest absolute magnitude in current sub-frame [k], and

XPK_{TH} is a predetermined threshold, and represents a ‘fixed noise floor’.

Control then passes to step 524.

In step 523, digital processing block 180 operates to determine whether a current sub-frame represents speech or not based on variations (differences) of peak values in frames, as described above with respect to flowchart of FIG. 3. The technique used by digital processing block 180 in step 523 may be referred to as dynamic VAD. Control then passes to step 524.

In step 524, digital processing block 180 checks whether the current sub-frame was determined as representing speech or noise. If the sub-frame represents speech (va[k]=1), control passes to step 531, otherwise control passes to step 510, in which digital processing block 180 receives (or forms) a new/next set, and the corresponding subsequent steps in the flowchart may be performed repeatedly.

In step 531, digital processing block 180 computes a ‘raw gain’ value (Graw) to be applied to the current sub-frame, and is based on the peak value (xpk) corresponding to the sub-frame, and a desired gained amplitude level.

As an illustration, the raw gain values for speech portions 222 and 224 of FIG. 2A may be selected such that the peak values of the respective portions equal the full-scale levels (260/270) (while the remaining samples are also gained by the same proportion/gain). The raw gain values may be stored in lookup tables in memory (e.g., storage 190 of FIG. 1), with the memory address mapping to the peak amplitude and the memory content storing the raw gain. In an embodiment of the present invention, a binary search technique (well-known in the relevant arts) is used to retrieve a raw gain value from the look-up table. Control then passes to step 532.

In step 532, digital processing block 180 subtracts a ‘headroom’ margin (e.g., margin 280 in FIG. 2A) from the raw gain to generate a gain factor ‘Grawh’. The subtraction is designed to limit the gain eventually applied to the sub-frame. Control then passes to 533.

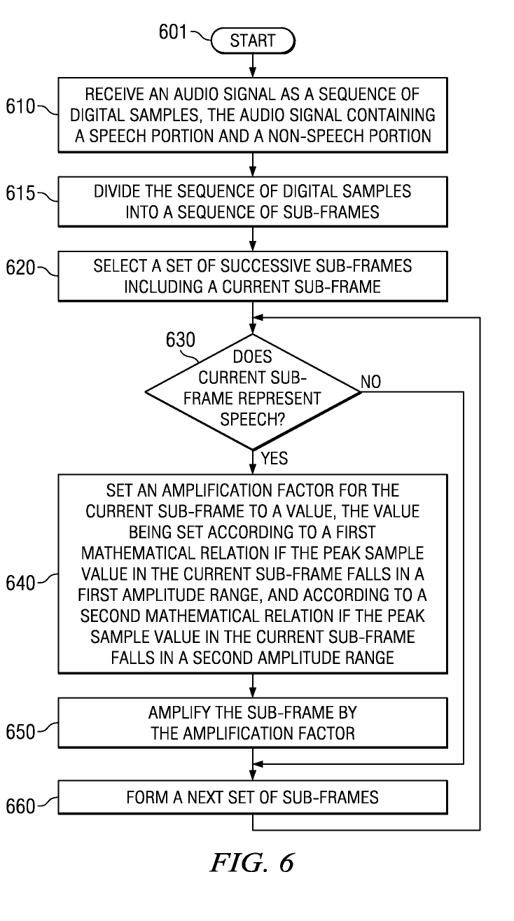

In step 533, digital processing block 180 retrieves for each ‘Grawh’ value, a corresponding final gain (target gain) Gs. The Gs values may be stored in a look-up table in storage 190. The correspondence/relationship between Grawh values and Gs values as specified by the lookup table represents a gain transformation (transformation from raw gain to a desired final gain value that is actually applied) that may be designed to enable features such as preservation of perception of distance, in addition constant-amplitude leveling for some speech segments, and gain limiting (clipping). The manner in which gain shaping may be provided is described in detail below with respect to flowchart of FIG. 6. The transformation of step 533 may be disabled (and Grawh itself provided as Gs) if such gain transformation and the resultant features are not desired. Control then passes to step 534.

In step 534, digital processing block 180 computes a gain change (from an immediately previously applied gain value) for the current sub-frame. Thus, for a gain Gs[k] (obtained after execution of step 533) greater than an immediately previous applied gain Gact[k−1] (applied in gain application phase 540), digital processing block 180 determines the corresponding increase in gain. For a gain Gs[k] lesser than the immediately previous applied gain Gact[k−1], digital processing block 180 determines the gain reduction. Digital processing block 180 provides the gain-change value (augmentation or reduction) thus computed, to gain application phase 540. Digital processing block 180 may provide the gain-change in the form of smaller fractional gain steps to minimize zipper noise.

In addition, the computed gain Gs[k] may be clipped (limited to a maximum allowable value) if the difference between Gs[k] and the immediately previous applied gain Gact[k−1] is greater than a predetermined threshold. Such clipping is provided based on the observation that when the difference (Gact[k−1]−Gs[k]) is greater than a positive threshold (GD_{TH}), there is a likelihood of signal-clipping if the current gain change is not applied sufficiently quickly.

To avoid such potential signal-clipping, digital processing block 180 may set a flag (flagClip) to indicate to an amplifier/attenuator (controlled in gain application phase 540) to perform fast gain change. In response to flagClip being set, gain reduction may be effected in a single step (or a small number of steps), rather than as a large number of steps, in order to prevent signal clipping. Control then passes to 541.

In step 541, digital processing block 180 checks whether the gain change is to be applied in the digital domain or analog domain. In general, if greater precision in the gained audio samples is desired, gain is applied in the analog domain, as indicated by step 543. On the other hand, if gain is required to be applied in very small steps, then gain may be applied digitally, as indicated by step 542. However, a combination of digital and analog gain change techniques can also be used, as indicated by the steps 544 and 545.

Digital processing block 180 may apply digital gain (step 542), for example, by multiplying the audio samples in the set (or frame) by the computed gain-change value. When gain application is desired to be provided in the analog domain, digital processing block 180 provides control signal 184 to analog processing block 140 or ADC 160, which in turn provide the gain. It is noted that when analog gain control is used in conjunction with static VAD (step 522), the predetermined threshold XPK_{TH} is increased or decreased depending on the current and initial analog gains. The gain difference between the current gain and initial gain is used to recompute a new value of threshold XPK_{TH}.

In an embodiment of the present invention, when static VAD technique is used, XPK_{TH} is initially specified by a user based on audio signal and noise floor characteristics. For example, when digital still camera 100 is operated in noisy environments (for example, public areas where several different sources audio may be present), XPK_{TH} may be specified to have a higher value. On the other hand, when digital still camera 100 is operated in quieter environments, XPK_{TH} may be specified to have a lower value. XPK_{TH} is varied as the gain setting of ADC 160 changes. Thus, if gain of ADC 160 is increased by ‘X’ dB, threshold XPK_{TH} is also increased by ‘X’ dB. Likewise, if gain of ADC 160 is decreased, XPK_{TH} is decreased by the same extent. This is done since any change in gain (amplification or attenuation) of ADC 160 causes the noise floor of the entire system also to be amplified or attenuated proportionally.

In general, digital processing block 180 causes the gain to be applied without inordinate delay, to prevent undesirable signal saturation or attenuation. Assuming a sign change occurs in the gain being applied (i.e., transition from amplification to attenuation, or from attenuation to amplification), the previously applied gain (amplification or attenuation) is gradually removed before application of the current gain.

As noted above, digital processing block 180 may also apply the computed gain as a combination of analog and digital gains. Such an approach may be desirable, for example, when the amount of analog gain change possible is limited, or for minimizing the effect of delay in gain application and/or improving precision of the gained digital samples. If the total gain (or gain change) cannot be (or is not desired to be) provided completely in the analog domain, digital processing block 180 provides the residual gain (yet to be applied) in the digital domain, as denoted by blocks 544 and 545. After operation of any of steps 544, 545 and 542, control passes to step 510, in which a next set of sub-frames is processed, and the operations of the steps of the flowchart may be repeated.

The manner in which gain shaping (of step 533) is performed in an embodiment of the present invention is described next.

7. Gain Shaping

FIG. 6 is a flowchart illustrating the manner in which gain shaping is provided, in an embodiment of the present invention. The flowchart is described with respect to FIGS. 1 and 2, and digital processing block 180, merely for illustration. However, various features described herein can be implemented in other environments, as will be apparent to one skilled in the relevant arts by reading the disclosure provided herein. The flowchart starts in step 601, in which control is transferred to step 610.

In step 610, digital processing block 180 receives an audio signal as a sequence of digital samples, the audio signal containing a speech portion and a non-speech portion. Control then passes to step 615. In step 615, digital processing block 180 divides the sequence of digital samples into a sequence of sub-frames. Control then passes to step 620.

In step 620, digital processing block 180 selects a set of successive sub-frames including a current sub-frame. The set of successive sub-frames is selected as a basis to determine if the current sub-frame represents speech or noise, in a manner described above with respect to the flowchart of FIG. 3. Control then passes to step 630.

In step 630, digital processing block 180 concludes whether the current sub-frame of the set represents a speech portion or a non-speech portion. Such a conclusion may be based on techniques described above with respect to FIGS. 3, 4 and 5. If digital processing block 180 concludes that the current sub-frame represents speech (va[k]=1), then control passes to step 640, otherwise control passes to step 660.

In step 640, digital processing block 180 sets an amplification factor to a value, with the value being set according to a first mathematical relation if the peak sample value in the current sub-frame falls in a first amplitude range, and according to a second mathematical relation if the peak sample value in the current sub-frame falls in a second amplitude range.

As an illustration, for peak amplitude ranges of low values (voice level low), it may be desirable to maintain distance perception when replaying the speech. Distance perception is preserved by providing a same gain for all peak amplitudes in the low-value range. On the other hand, for a higher input amplitude range it may be desirable to level the corresponding gained outputs to a constant level. Hence for such a higher range gain values having an inverse correlation with the input amplitude is used. Control then passes to step 650.

In step 650, digital processing block 180 amplifies the sub-frame by the amplification factor. Digital processing block 180 may cause the amplification to be performed (gain to be applied) gradually (in smaller steps), as noted above with respect to FIG. 5. Control then passes to 660, in which digital processing block 180 forms a next set of sub-frames. Control then passes to step 630, and the corresponding operations of the flowchart may be repeated.

Example gain curves that enable various features such as retention of distance perception, constant leveling, or combinations of the two are provided next.

8. Example Gain Curves

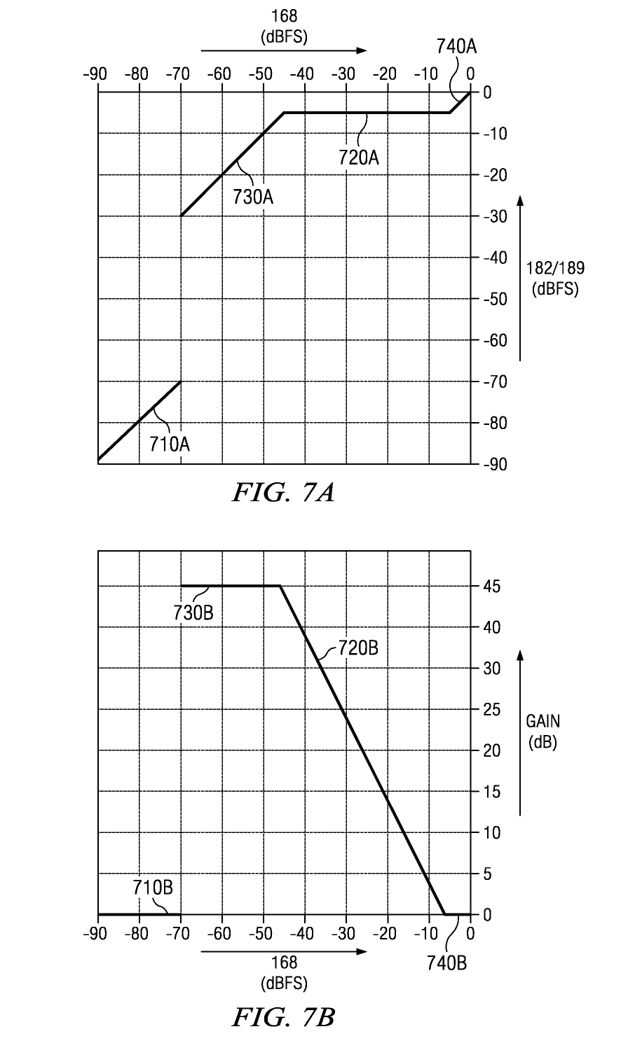

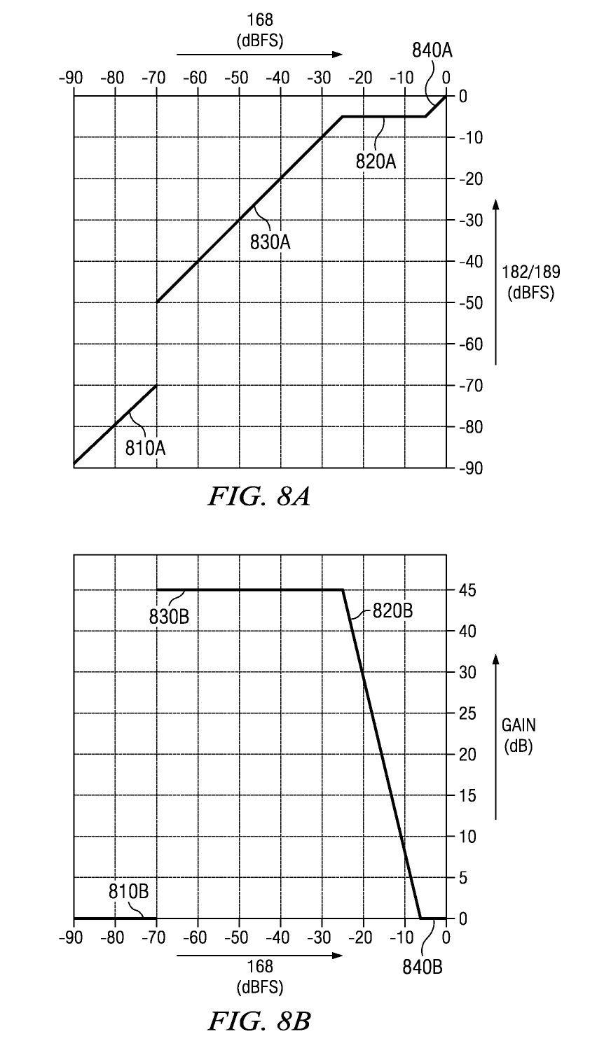

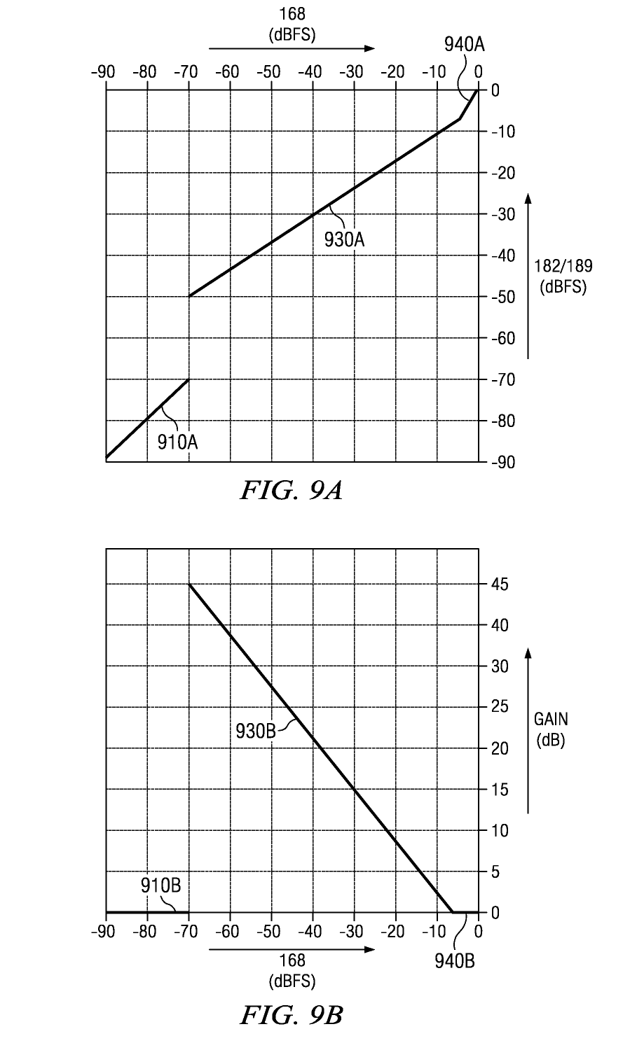

Graphs of FIGS. 7A, 8A and 9A illustrate the relationship between input amplitudes and processed-output amplitudes of an audio signal in embodiments of the present invention. Graphs 7B, 8B and 9B illustrate the gain curves corresponding to the graphs of 7A, 8A and 9A respectively. The input (path 168) and output (path 182/189) amplitude ranges are specified in the respective Figures in terms of decibels (dB) below full-scale (0 dB), and the gain values are specified in decibels (dB).

In graph 7A, outputs corresponding to input amplitudes in range denoted by 720A are desired to be leveled to a constant amplitude. Ranges 710A and 730A represent ranges for which distance perception is to be preserved. Inputs in highest amplitude range 740A are desired to be prevented from being clipped. The gain values corresponding to the ranges 710A, 720A, 730A and 740A are shown in graph 7B by sections denoted by 710B, 720B, 730B and 740B respectively. It may be observed that the gain settings of graph 7B have sections, at least two of which are described by different mathematical relations.

Gain values in section 720B have progressively smaller values for larger input amplitudes, as desired for leveling the corresponding input amplitude range represented by 720A. On the other hand, gain values in each of sections 710A and 730A have respective constant values of 0 and 45 dB. Thus, distance perception is preserved for input amplitudes in the ranges 710A and 730A.

Graphs 8A and 8B illustrate input-output and input-gain relationships in another embodiment, with gain values corresponding to the ranges 810A, 820A, 830A and 840A respectively represented by sections denoted by 810B, 820B, 830B and 840B. Graphs 9A and 9B illustrate input-output and input-gain relationships in yet another embodiment, with gain values corresponding to the ranges 910A, 930A and 940A respectively represented by sections denoted by 910B, 930B and 940B.

It may be observed that the lowest ranges 710A, 810A and 910A have a corresponding constant gain (710B, 810B and 910B), which causes distance perception to be maintained when the input amplitudes fall in the (lowest) range. Portions 730A, 830A and 930A are amplified by a second constant gain value greater than the gain applied for portion 710A, 810A and 910A, with the result that the distance perception is maintained, but a greater gain is provided.

Also, the gains (720B and 820B) for the input amplitudes in ranges 720A and 820A are inversely proportionate to the corresponding input amplitude, which causes the output to be generated at a substantially high constant level. However, other relationships which have negative correlation (i.e., when the input amplitude increases, the output amplitude reduces), can be used in alternative embodiments.

The input amplitude ranges represented by 740A, 840A and 940A correspond to the highest amplitude ranges possible and the gains corresponding to these ranges are also set to constant value as represented by 740B, 840B and 940B.

The graphs described above are provided merely by way of illustration, and various other specific gain curves or input-output amplitude relationships are also possible.

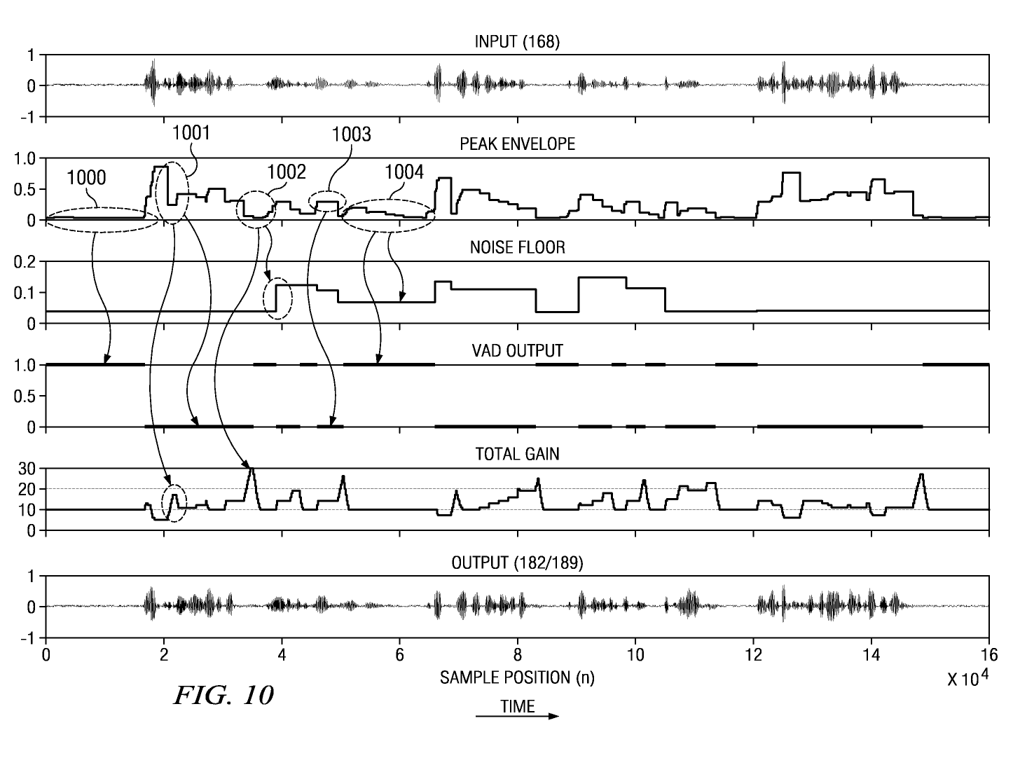

FIG. 10 illustrates graphically some of the techniques described above, and is shown containing input audio signal (168), filtered peak values of audio signal 168, corresponding noise floor values, speech/non-speech decisions (denoted by ‘VAD output’), gain values generated by digital processing block 180 for the respective input signal portions, and the processed output audio signal (182/189). A ‘VAD output’ value of 1 signifies that the corresponding input audio segment is determined to be noise, while a ‘VAD output’ value of 0 signifies that the corresponding input audio segment is determined to represent speech.

As an example, it may be observed from the Figure that the peak values (filtered pseudo envelope of input 168) in section 1000 have a very low value, Accordingly, audio section 1000 is determined as noise (VAD output 1). Filtered peak values in section 1001 show substantial variations, and the corresponding input portion is determined to be speech (VAD output 0). Due to application of gain for the audio segment corresponding to peak values denoted by 1002, the noise floor value increases.

Input segment corresponding to peak values in section 1003 is determined as speech (even though the corresponding noise floor values are relatively high), since the peak values do not exhibit substantial variations (as may be noted from the relatively flat section). Gain values applied for the speech segments corresponding to sections 1001 and 1003 are also indicated.

With respect to section denoted as 1004, the corresponding input segment is determined to be noise even though the noise floor values are high. Such a determination may be made since the corresponding peak values do not exhibit substantial variation, and therefore a default decision of noise may be maintained. Other portions of FIG. 10 may be observed to note the operation of the techniques described in detail above.

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of processing audio signals, said method comprising:
receiving an audio signal as a sequence of digital samples, said audio signal containing a speech portion and a non-speech portion;
dividing said sequence of digital samples into a sequence of sub-frames;
selecting a set of sub-frames from said sequence of sub-frames, said set including a current sub-frame;
determining whether a difference of peak values for any pair of sub-frames is greater than a pre-determined threshold, wherein said pair of sub-frames are contained in said set of sub-frames; and
concluding that said current sub-frame represents said speech portion if said difference of peak values exceeds said pre-determined threshold.

2. The method of claim 1, further comprising:
comparing a highest peak value of said set of sub-frames with a noise floor,
wherein said concluding concludes that said current sub-frame represents said non-speech portion if said highest peak value is less than said noise floor.

3. The method of claim 2, further comprising:
changing said noise floor dynamically as successive segments of said audio signal are processed.

4. The method of claim 3, wherein said changing comprises:
setting said noise floor to equal a lowest peak value of said set of sub-frames if said current sub-frame is determined to represent said speech portion.

5. The method of claim 4, wherein said current sub-frame is concluded as said non-speech portion or not, before being concluded as said speech portion,
whereby said current sub-frame is concluded as said speech portion only if said current sub-frame is not concluded as non-speech portion.

6. The method of claim 5, further comprising:
equating an amplification factor to a value based on said highest peak value; and
amplifying said current sub-frame by said amplification factor only if said current sub-frame is deemed to represent said speech portion.

7. The method of claim 6, wherein said equating comprises:
dividing a total amplitude range of said audio signal to at least two ranges which are non-overlapping, wherein said value is selected to be a constant value if said highest peak value is in a first range and selected to have a positive correlation to said highest peak value if said highest peak value is in a second range, wherein said first range and said second range are contained in said at least two ranges.

8. A machine readable medium storing one or more sequences of instructions for enabling a system to process audio signals, wherein execution of said one or more sequences of instructions by one or more processors contained in said system causes said system to perform the actions of:
receiving an audio signal as a sequence of digital samples, said audio signal containing a speech portion and a non-speech portion;
dividing said sequence of digital samples into a sequence of sub-frames;
selecting a set of sub-frames, including a current sub-frame, from said sequence of sub-frames;
changing a noise floor based on the values of said sequence of digital samples; and
concluding that said current sub-frame represents said non-speech portion if a highest peak value of said set of sub-frames is less than said noise floor.

9. The machine readable medium of claim 8, wherein said changing comprises:
setting said noise floor to equal a lowest peak value of said set of sub-frames if said current sub-frame is determined to represent said non-speech portion.

10. The machine readable medium of claim 9, further comprising:
determining whether a difference of peak values for any pair of sub-frames is greater than a pre-determined threshold, wherein said pairs of sub-frames are contained in said set of sub-frames; and
concluding that said current sub-frame represents said speech portion if said difference of peak values exceeds said pre-determined threshold,
wherein said current sub-frame is concluded to be contained in said speech portion only after said current sub-frame is concluded not to represent said non-speech portion.

11. The machine readable medium of claim 9, further comprising:
setting an amplification factor to a value based on said highest peak value and amplifying said current sub-frame by said amplification factor only if said current sub-frame represents said speech portion,
wherein said value is set according to a first mathematical relation if a highest peak of said set of sub-frames falls in a first amplitude range and according to a second mathematical relation if said highest peak falls in a second amplitude range.

12. A digital processing system comprises:
a random access memory (RAM);
a processor; and
a machine readable medium to provide a set of instructions which are retrieved into said RAM and executed by said processor, wherein execution of said set of instructions causes said digital processing system to perform the actions of:
receiving an audio signal as a sequence of digital samples, said audio signal containing a speech portion and a non-speech portion;
dividing said sequence of digital samples into a sequence of sub-frames;
selecting a set of sub-frames, including a current sub-frame, from said sequence of sub-frames;
concluding whether said current sub-frame represents said speech portion or said non-speech portion;
setting an amplification factor to a value, wherein said value is set according to a first mathematical relation if a highest peak of said set of sub-frames falls in a first amplitude range and according to a second mathematical relation if said highest peak falls in a second amplitude range; and
amplifying said current sub-frame by said amplification factor only if said current sub-frame is concluded to represent said speech portion.

13. The digital processing system of claim 12, wherein said first amplitude range corresponds to a lower range compared to said second amplitude range.

14. The digital processing system of claim 13, wherein said first amplitude range includes a lowest range of the amplitude values of said audio signal, wherein said first mathematical relation equals a first constant value such that distance perception is preserved for segments of audio signals in said first amplitude range.

15. The digital processing system of claim 14, wherein said second mathematical relation has a negative correlation with an amplitude of said highest peak when said amplitude falls in said second amplitude range.

16. The digital processing system of claim 15, wherein said negative correlation is an inverse correlation such that the amplified values are substantially constant for digital samples falling in said second amplitude range.

17. The digital processing system of claim 16, wherein said value is set to a second constant value greater than said first constant value if said highest peak falls in a third amplitude range, which is between said first amplitude range and said second amplitude range.

18. The digital processing system of claim 15, wherein said value is set to said first constant value if said highest peak falls in a highest amplitude range of said audio signal.

19. The digital processing system of claim 18, said actions further comprising:
determining whether a difference of peak values for any pair of sub-frames is greater than a pre-determined threshold, wherein each of said pair of sub-frames are contained in said set of sub-frames,
wherein said concluding concludes that said current sub-frame represents said speech portion if said difference of peak values exceeds said pre-determined threshold.

20. The digital processing system of claim 18, wherein said concluding concludes that said current sub-frame represents said non-speech portion if said highest peak of the digital samples of said set of sub-frames is less than a noise floor, said actions further comprising:
setting said noise floor to equal a lowest peak value of said set of sub-frames if said current sub-frame is determined as representing said speech portion.
